(19) United States
(12) Patent Application Publication
(10) Pub. No.: US 2022/0261448 A1
(43) Pub. Date: Aug. 18, 2022

(54) INFORMATION RECOMMENDATION DEVICE, INFORMATION RECOMMENDATION SYSTEM, INFORMATION RECOMMENDATION METHOD AND INFORMATION RECOMMENDATION PROGRAM

(71) Applicant: NIPPON TELEGRAPH AND TELEPHONE CORPORATION, Tokyo (JP)

(72) Inventors: Osamu KAMATANI, Musashino-shi, Tokyo (JP); Takeshi KUGIMOTO, Musashino-shi, Tokyo (JP); Takahiro YAMAGUCHI, Musashino-shi, Tokyo (JP)

(73) Assignee: NIPPON TELEGRAPH AND TELEPHONE CORPORATION, Tokyo (JP)

(21) Appl. No.: 17/624,751

(22) PCT Filed: Jul. 5, 2019
(86) PCT No.: PCT/JP2019/026830

§ 371 Date: Jan. 4, 2022

(51) Int. Cl. G06F 16/9532; G06N 5/02

(52) U.S. Cl. CPC G06F 16/9532; G06N 5/02

(57) ABSTRACT

An object of the present disclosure is to recognize a situation during a user's conversation as a context and make it possible to present items suitable for the situation.

An information recommendation apparatus 100 according to the present disclosure includes a context extraction module 24 which extracts keywords which are in a topic from a user's conversation, a similarity determination module 31 which refers to a knowledge base 13 storing recommended items associated with communication contexts including keywords, extracts recommended items and communication contexts associated with the extracted keywords, and selects communication contexts similar to the topic among the extracted communication contexts, and an information search module 32 which acquires from the knowledge base 13 recommended items associated with the selected communication contexts.

### TECHNICAL FIELD

The present disclosure relates to communication and information communication.

### BACKGROUND ART

Communication means is diversifying due to progress of information and communication technology. Voice calls by telephone and the like were the mainstream in the past, but communication using text messages, pictographs and the like has increased significantly in recent years. In addition, the spread of smartphones has greatly changed forms of communication, and it has become possible to communicate in real time by transmitting and receiving messages with each other. Furthermore, vast contents are produced and distributed day by day, and users appropriately search for and select contents they are interested in, and share the acquired contents with each other as communication through social network services.

With such a background, objective information and contents are exchanged mainly by text messages, while interpersonal communication is becoming more important to share subjective information and sentiment more deeply. In interpersonal communication, it is indispensable to exchange each other's thoughts by dialogue, but appropriate topics may not be immediately conceived, or mutual dialogue may not become active depending on choice of topics. From such a point of view, there is a need for an approach for providing appropriate topics and information to make communication active, in interpersonal communication.

Also in communication via text messages, there is a need for an approach for providing information such as knowledge, news, topics and video contents suitable for contents during dialogue to promote communication. There is an information recommendation system (Non-Patent Literature 1) as a means for searching for and providing appropriate information from vast contents, and since the information recommendation system appeared in the 1990s, various recommendation systems have been considered and put into practical use. As an example, information recommendation systems are used in contents distribution services and the like such as online shopping, music distribution, movies, and video distribution. In the information recommendation systems, approaches such as collaborative recommendation, content-based recommendation and knowledge-based recommendation are known as conventional technology, and a hybrid approach is considered to be valid, which uses a combination of various approaches to make more accurate recommendations.

Non-Patent Literature 2 is a system called a mixed hybrid, which presents all presentation results from a plurality of different recommendation systems to a user.

Non-Patent Literature 3 is a system called a weighting hybrid strategy, which presents recommendation results to a user by giving appropriate weights to recommendation results from a plurality of different recommendation systems.

However, it has been difficult to apply the conventional information recommendation technology, which has been developed mainly for the purpose of inducing purchase, to an approach for providing appropriate topics and information to make communication active, in interpersonal communication. Moreover, in the conventional information recommendation technology intended for purchasing, music or the like, it is known to perform hybrid processing which combines a plurality of approaches, but it is not fully disclosed how to apply the hybrid processing to providing topics and information in interpersonal communication, and how to combine and use the plurality of approaches.

The conventional technology shown in Non-Patent Literature 2 and 3 is mainly for the purpose of advertising and purchasing, and its application to interpersonal communication is not considered. In interpersonal communication, it is necessary to take into account a topic in a current conversation, proposal of contents related to the topic, a situation where the conversation is taking place, and the like. Interpersonal communication here refers to general communication in a broad sense, such as person-to-person conversation in language and dialogue via text messages.

### CITATION LIST

### Non-Patent Literature

Non-Patent Literature 1: “Joho Suisen Sisutemu Nyumon (in Japanese)” (Japanese Translation of “Recommender Systems: An Introduction” (Cambridge University Press, 2011)), Translation Supervised by Katsumi Tanaka and Kazutoshi Sumiya, Kyoritsu Shuppan Co., Ltd., 2012
Non-Patent Literature 2: Markus Zanker, Markus Aschinger and Markus Jessenitschnig, “Development of a Collaborative and Constraint-Based Web Configuration System for Personalized Bundling of Products and Services”, 8th International Conference on Web Information Systems Engineering, Nancy, France., 2007 (LNCS, 4831), pp. 273-284.
Non-Patent Literature 3: Markus Zanker and Markus Jessenitschnig, “Case-studies on exploiting explicit customer requirements in recommender systems”, User Modeling and User-Adapted Interaction, vol. 19(1-2), 2009, pp. 133-166.
Non-Patent Literature 4: RDF 1.1 Concepts and Abstract Syntax, W3C Recommendation 25 Feb. 2014, https://www.w3.org/TR/rdf11-concepts/.
Non-Patent Literature 5: OWL 2 Web Ontology Language Document Overview (Second Edition), W3C Recommendation 11 Dec. 2012, https://www.w3.org/TR/ow12-overview/.
Non-Patent Literature 6: SPARQL Query Language for RDF. W3C Recommendation, January 2008. https://www.w3.org/TR/rdf-sparql-query/
Non-Patent Literature 7: SPIN (SPARQL Inference Notation). http://spinrdf.org/

### SUMMARY OF THE INVENTION

### Technical Problem

An object of the present disclosure is to make it possible to recognize a situation during a user's conversation as a context and present items suitable for the situation.

### Means for Solving the Problem

In order to achieve the above object, the present disclosure prepares a knowledge base in which recommended items and communication contexts are associated, extracts keywords in a user's conversation, refers to the knowledge base to extract communication contexts suitable for the conversation from the keywords, and presents the user with recommended items searched for based on the communication contexts.

Specifically, an information recommendation apparatus according to the present disclosure includes

a context extraction module which extracts keywords which are in a topic from a user's conversation,

a similarity determination module which refers to a knowledge base storing recommended items associated with communication contexts including keywords, extracts recommended items and communication contexts associated with the extracted keywords, and selects communication contexts similar to the topic among the extracted communication contexts, and

an information search module which acquires from the knowledge base recommended items associated with the selected communication contexts.

Specifically, an information recommendation system according to the present disclosure includes

the information recommendation apparatus according to the present disclosure,

a recommended item collection module which collects contents which may become the recommended item, and

a communication context label extraction module which extracts keywords from the contents collected by the recommended item collection module, associates the extracted keywords with communication contexts of the contents, and stores them in the knowledge base.

Specifically, in an information recommendation method according to the present disclosure, the information recommendation apparatus according to the present disclosure

extracts keywords which are in a topic in conversation,

refers to a knowledge base storing recommended items associated with communication contexts including keywords, extracts recommended items and communication contexts associated with the extracted keywords,

selects communication contexts similar to the topic among the extracted communication contexts, and

acquires from the knowledge base recommended items associated with the selected communication contexts.

Specifically, an information recommendation program according to the present disclosure is a program for causing a computer to execute each step provided in the method according to the present disclosure, and is a program for realizing a computer as each functional unit provided in the apparatus according to the present disclosure.

### Effects of the Invention

According to the present disclosure, it is possible to recognize a situation during a user's conversation as a context and present items suitable for the situation.

### BRIEF DESCRIPTION OF DRAWINGS

FIG. 1 is an example of a module configuration of a first system of the present disclosure.

FIG. 2 is an example of a module configuration of a second system of the present disclosure.

FIG. 3 is an example of a processing approach of contexts and recommended items.

FIG. 4 is a first example of a recommended item generation processing procedure example.

FIG. 5 is a second example of the recommended item generation processing procedure example.

FIG. 6 shows a processing example of recommended items and contexts.

FIG. 7 shows a structure example of recommended items and context data.

FIG. 8 is an example of an instance diagram of recommended items and context data.

FIG. 9 is an example of instance representation of a recommended item.

FIG. 10 shows a description example of a recommended item search rule.

FIG. 11 is an example of instance representation of a keyword.

FIG. 12 shows a description example of a keyword linked search rule.

FIG. 13 shows an example of a hardware configuration of the present disclosure.

### DESCRIPTION OF EMBODIMENTS

Hereinafter, embodiments of the present disclosure are described in detail with reference to the drawings. The present disclosure is not limited to the embodiments shown below. These examples of implementation are merely exemplary, and the present disclosure can be implemented in forms with various alterations and improvements based on knowledge of those skilled in the art. Components having the same reference characters in this specification and the drawings shall mutually indicate the same components.

(Module Configuration)

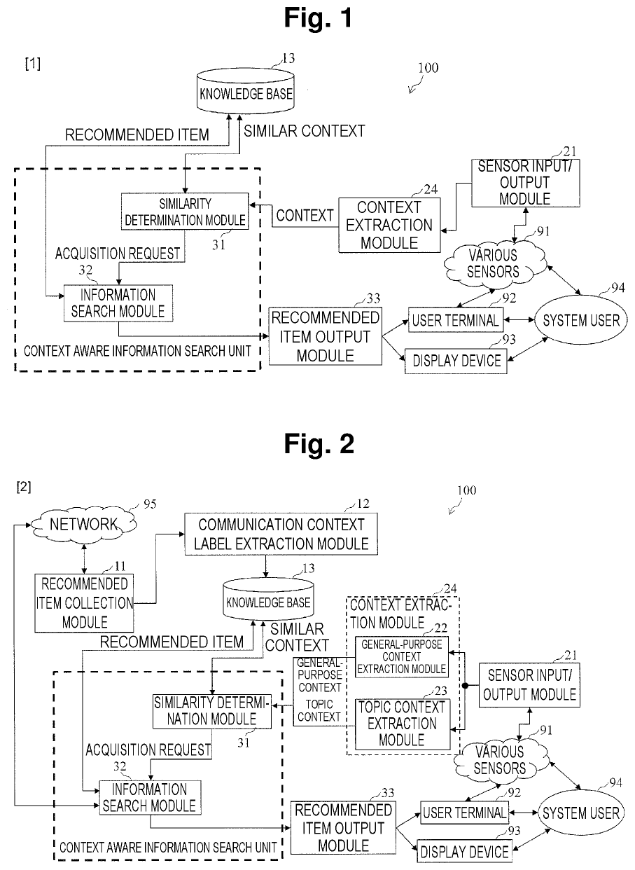

FIG. 1 shows a module configuration diagram of a first system according to the present disclosure. The system of the present disclosure includes a knowledge base 13, a context extraction module 24, a similarity determination module 31 and an information search module 32.

FIG. 2 shows a module configuration diagram of a second system according to the present disclosure. The second system of the present disclosure further includes a recommended item collection module 11 and a communication context label extraction module 12, in addition to the first system. In addition, the context extraction module 24 includes a general-purpose context extraction module 22 and a topic context extraction module 23. Hereinafter, each configuration of the present disclosure is described.

The knowledge base 13 is a database prepared in advance, and stores a set of recommended items and contexts for a user 94. In the present disclosure, the context extraction module 24 extracts keywords which are in a topic, and the similarity determination module 31 uses the keywords to extract communication contexts suitable for the topic from the knowledge base 13, and the information search module 32 uses the extracted communication contexts to perform information search.

Here, the keywords extracted by the context extraction module 24 may include a keyword representing a situation during conversation such as sentiment. This allows the similarity determination module 31 to extract communication contexts suitable for the situation during conversation. Extraction of communication contexts is not only from keywords in conversation. For example, by preparing the general-purpose context extraction module 22 shown in FIG. 2, information from any sensor 91 can be used. Hereinafter, the system of the present disclosure is described with reference to a system configuration shown in FIG. 2.

A recommended item is for at least one of participants in conversation and may be shared by two or more users. When it is shared by two or more users, the knowledge base 13 may further store a user profile to identify the user 94. This makes it possible to provide recommended items suitable for the user 94.

The system of the present disclosure includes the recommended item collection module 11 and the communication context label extraction module 12 to store a set of recommended items and communication contexts in the knowledge base 13. The recommended item collection module 11 automatically collects contents which may become recommended items from the Internet and the like. A recommended item is any content which can be acquired from a network 95, and for example, is news or video, or an address linked to them. The collected recommended items are sent to the communication context label extraction module 12. The communication context label extraction module 12 determines the communication context of the recommended item and stores the recommended item in the knowledge base (Knowledge Base; KB) 13 with a context label associated with the recommended item.

Here, any method can be used for the context label for the recommended item in the communication context label extraction module 12. For example, structured data according to an ontology based on RDF (Resource Description Framework) and OWL (Web Ontology Language) can be used (Non-Patent Literature 4 and 5). Further, in the knowledge base 13, a context rule based on SPIN (SPARQL Inferencing Notation) may be stored together (Non-Patent Literature 6 and 7).

The sensor 91, a display device 93 such as a display, a user terminal 92 such as a smartphone, and the like are arranged around the system user 94. The sensor 91 is any one or more sensors, and includes a microphone, a camera, a clock, and a thermometer. A sensor input/output module 21 acquires information from the sensor 91 and sends out necessary information to the general-purpose context extraction module 22 and the topic context extraction module 23.

For example, when the sensor 91 is a microphone which acquires voice data of the system user 94, the sensor input/output module 21 converts the voice data into text data and outputs it to the topic context extraction module 23. At this time, the sensor input/output module 21 may convert the voice data into feature quantity such as volume, sound quality, and frequency components, and output it to the general-purpose context extraction module 22. When the sensor 91 is a camera which captures facial expression of the system user 94, the sensor input/output module 21 outputs image data to the general-purpose context extraction module 22.

The general-purpose context extraction module 22 extracts general-purpose contexts such as time information, environmental information, the user's location information, video information such as the user's facial expression and media being viewed, a sentiment analysis category, and a sentiment analysis score, from sensor information obtained by the sensor input/output module 21. For example, the general-purpose context extraction module 22 uses at least one of feature quantity obtained from voice data including volume, sound quality and frequency components, and the user's facial expression included in an image to extract a sentiment category and a sentiment analysis score which are one of the general-purpose contexts. The topic context extraction module 23 extracts a topic context representing the topic of the current conversation, from the user's conversation. The contexts obtained by the general-purpose context extraction module 22 and the topic context extraction module 23 are sent out to the similarity determination module 31.

The similarity determination module 31 extracts keywords suitable for the topic from a plurality of keywords included in the received topic context, and queries the knowledge base 13 about them. The similarity determination module 31 can acquire from the knowledge base 13, similar contexts which are a list of communication contexts similar to the topic context among communication contexts including the keywords. The similarity determination module 31 discriminates the similar contexts acquired from the knowledge base 13, and makes an acquisition request to the information search module 32, for recommended items having in context labels, the similar contexts determined to be necessary.

For example, in the case where a user A tells a user B about a movie he went to see yesterday, a conversation sentence “Yesterday I went to see a movie in Shibuya at night and it is Star Wars . . . ” includes four keywords “yesterday,” “Shibuya,” “movie” and “Star Wars (a title of a movie)”. “Yesterday” belongs to a lower context of “date and time”, “Shibuya” belongs to a lower context of “place name”, and “Star Wars (a title of a movie)” belongs to a lower context of “movie”. In this case, the similarity determination module 31 infers that when and where the movie was seen is not the focus of the current topic, and determines that the keywords belonging to the date and time and the place name, “yesterday” and “Shibuya” have low similarity as the current communication context. As a result, the similarity determination module 31 determines that two keywords “movie” and “Star Wars (a title of a movie)” have high similarity to the current communication context, and requests the knowledge base 13 to search for contexts similar to them.

Later, in the case where after the user A and the user B continued conversation on the topic about the movie, the topic changed by the user B shifting the conversation to another topic like “Speaking of Shibuya, there is a cafe scheduled to open in July in Mark City, and I want to go there next time . . . ”, four keywords “Shibuya”, “Mark City”, “July” and “cafe” are extracted from this conversation sentence. “Shibuya” belongs to a lower context of “place name”, “Mark City” and “cafe” belong to a lower context of “spot”, and “July” belongs to a lower context of “date and time”. In this case, the similarity determination module 31 infers that the date and time is not the focus of the current topic, and determines that the keyword belonging to the date and time, “July” has low similarity as the current communication context. As a result, the similarity determination module 31 determines that three keywords “Shibuya”, “Mark City” and “Cafe”, which have “place name” and “spot” as higher contexts, have high similarity to the current communication context, and requests the knowledge base 13 to search for contexts similar to them.

The information search module 32 queries at least one of the knowledge base 13 and the network 95 to search for recommended items matching the acquisition request. The information search module 32 sends out the recommended items obtained as a search result to the recommended item output module 33. The recommended item output module 33 presents the recommended items obtained from the information search module 32 to the user 94 via the display device 93, the user terminal 92 or the like.

Here, the extraction or selection of the keywords or contexts in the similarity determination module 31 is performed using a context hierarchy, and similarity of the higher context or the lower context. For example, scores representing similarity of the higher context and the lower context are calculated, and the context having a higher similarity score is extracted or selected. As to the extraction or selection, contexts having a certain score or higher may be extracted or selected, or a predetermined number of contexts in descending order of score may be extracted or selected.

General cosine similarity can be used for the calculation of the score, and the item evaluation by the user stored in the knowledge base 13 may be used. In this embodiment, sets of item keywords and context keywords are prepared, but the exact same keywords do not always hit. Therefore, sets of similar words are stored in the knowledge base 13 and the similarity determination module 31 may refer to them. In this case, the similarity determination module 31 can use semantic similarity in the set of similar words as the score.

In calculating the score, in addition to the topic context obtained from the current user's conversation, contexts obtained from the past user's conversation may be used. Further, in calculating the score, similarity between the past user and current other users may be used. In these cases, the context obtained from the past user's conversation is stored in the knowledge base 13.

When the context obtained from the past user's conversation is used in calculating the score, the recommended item collection module 11 and the communication context label extraction module 12 determine the communication context for the user's conversation as well, as with the recommended item, and store it in the recommended item/communication context label knowledge base 13.

### First Embodiment

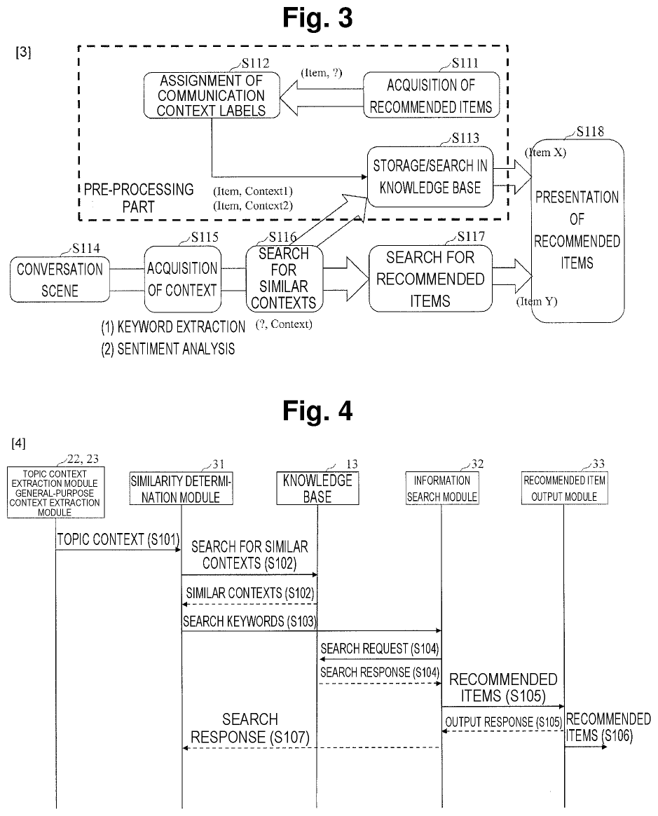

In this embodiment, the processing approach of the communication context and the recommended item is described. FIG. 3 shows an explanatory diagram of the processing approach of the communication context and the recommended item. Acquisition S111 of recommended items, assignment S112 of context labels, and storage S113 in the knowledge base are executed before S114 to S118.

In acquisition S111 of recommended items, the recommended item collection module 11 acquires contents which may become candidates for recommended items from the Internet or content services in advance. In assignment S112 of communication context labels, the communication context label extraction module 12 extracts the communication context of the recommended item by performing keyword extraction, sentiment analysis and the like for each recommended item, and assigns a label of the extracted communication context to the recommended item. As such, a data set of the recommended item and the communication context corresponding to it is stored in the knowledge base 13.

In a conversation scene S114 of interpersonal communication, acquisition S115 of a context and a search S116 for recommended items are performed. In acquisition S115 of a context, the topic context extraction module 23 analyzes text data to see what kind of topic the conversation is taking place about, and performs keyword extraction. As such, the topic is extracted as a keyword. As to contents of the conversation, the sensor 91 such as a microphone is used, voice data is converted into text data, and keywords are extracted from the obtained text data.

In acquisition S115 of a context, the general-purpose context extraction module 22 analyzes sentiment from facial expression of people during conversation, feature quantity of voice, and the like to acquire a sentiment analysis category and a sentiment analysis score. As to facial expression of people, the sensor 91 such as a camera is used, and sentiment is analyzed from image recognition of facial expression of people.

In the search S116 for similar contexts, the similarity determination module 31 uses as a context the keywords, the sentiment analysis category and the sentiment analysis score obtained in this way, and searches for sets of a recommended item and a context corresponding to the context. This gives similar contexts. The similar context here may include general-purpose contexts such as general-purpose time information, environmental information, the user's location information, and video information such as the user's facial expression and media being viewed.

In a search S117 for recommended items, the information search module 32 obtains a search result of the recommended items by searching contents on the Internet or the like or searching the knowledge base 13, using the similar contexts. The recommended items obtained from the search result are presented to the user 94 during conversation (S118).

### Second Embodiment

FIG. 4 shows a sequence diagram in a system according to this embodiment. The system of this embodiment searches contents in the knowledge base 13.

The topic context extraction module 23 extracts a topic context representing the topic of the current conversation, from the user's conversation and transmits it to the similarity determination module 31 (S101). This updates the topic context in the similarity determination module 31.

The similarity determination module 31 queries the knowledge base 13 for similar contexts similar to the topic context (S102). As such, the similarity determination module 31 obtains a list response of similar contexts.

The similarity determination module 31 uses the obtained list of similar contexts to generate search keywords used to search for recommended items, and transmits it to the information search module 32 (S103). The generation of the search keywords is performed using a context hierarchy, and similarity of a higher context or a lower context.

The information search module 32 transmits the received search keywords to the knowledge base 13 as a search request for recommended items (S104). The knowledge base 13 returns recommended items matching the search keywords to the information search module 32, as a search response to the search request (S104).

The information search module 32 transmits the obtained recommended items to the recommended item output module 33 (S105), and the recommended item output module 33 presents the recommended items to the user 94 (S106).

The general-purpose context from the general-purpose context extraction module 22 is also sent out to the similarity determination module 31 (S101), as with the topic context from the topic context extraction module 23. In this case, the similarity determination module 31 acquires similar contexts matching both the topic context and the general-purpose context (S102).

### Third Embodiment

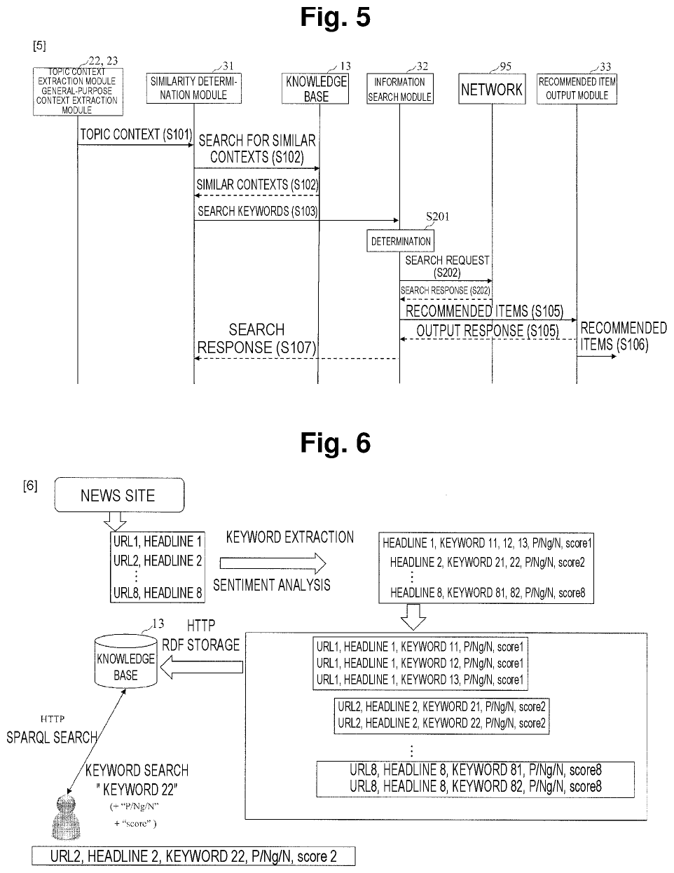

FIG. 5 shows a sequence diagram in a system according to this embodiment. The system of this embodiment searches contents on the Internet or the like.

A difference from the procedure shown in FIG. 4 is that the information search module 32 transmits a search request for recommended items to the network 95 which holds Internet contents, map information and the like. When location information such as a proper noun, a place name and a spot is included in the topic context, it may be desirable to search the network 95 instead of the knowledge base 13. So, the information search module 32 determines whether or not to search the network 95 by analyzing the search keywords from the similarity determination module 31 (S201).

When searching the network 95, the information search module 32 uses a predetermined search rule for extracting proper nouns, place names, spots and the like, to make a search request to the network 95 (S202). In this case, the information search module 32 determines whether or not it is desirable for the search, and transmits the search request to the network 95 which is likely to hold appropriate contents.

When making a search request to the network 95, the information search module 32 may make not only a search request to the network 95 which holds contents (S202) but also a search request to the knowledge base 13 (S104). In this way, the present disclosure may transmit the search request to either the knowledge base 13 or the network 95 which holds contents, or may make the search requests to both.

### Fourth Embodiment

FIG. 6 shows a processing example of recommended items and contexts stored in the knowledge base. In this embodiment, the recommended item collection module 11 acquires URLs and headlines of news from a news site providing news contents which may become recommended items.

The communication context label extraction module 12 performs keyword extraction and sentiment analysis on the acquired headline. The communication context label extraction module 12 stores the URL, the headline, extracted keywords, a sentiment analysis category and a sentiment analysis score of the news as structured RDF data in the knowledge base 13. As such, the knowledge base 13 stores a set in which a news content, which is a recommended item, is associated with a context label including keywords, a sentiment analysis category and a sentiment analysis score.

The sentiment analysis category here indicates which one of categories of “Positive” (P: optimistic), “Negative” (Ng: pessimistic) and “Neutral” (N: neutral) the contents of the recommended item are classified into. In this embodiment, it is possible to analyze the acquired headline by natural language processing to determine the sentiment analysis category of the news contents. The sentiment analysis score is a score obtained by evaluating degree of a result of the sentiment analysis with a numerical value from 0 to 1 for the obtained sentiment analysis category.

Protocols such as HTTP can be used to store data in the knowledge base 13. When it is desired to search the knowledge base 13 for recommended items, it is possible to input and search for a specific search keyword corresponding to the recommended items, and to obtain the recommended items matching it as a search result.

Similarly, when the general-purpose context extraction module 22 uses facial expression of a person during conversation, and the like to analyze the current sentiment and this gives a sentiment analysis result of the Negative category for a person with dark facial expression, the information search module 32 searches for recommended items in the “Positive” category which is classified into the opposite sentiment analysis category, in order to make the conversation active. As such, in this embodiment, it is possible to present the recommended items which make the conversation active, in order from the one with the highest score.

The information search module 32 can also use as a context, time information, environmental information, the user's location information, video information such as the user's facial expression and media being viewed, and the like acquired by the general-purpose context extraction module 22, and obtain appropriate recommended items as a search result. To search the knowledge base 13 for recommended items, protocols such as HTTP and SPARQL queries can be used.

### Fifth Embodiment

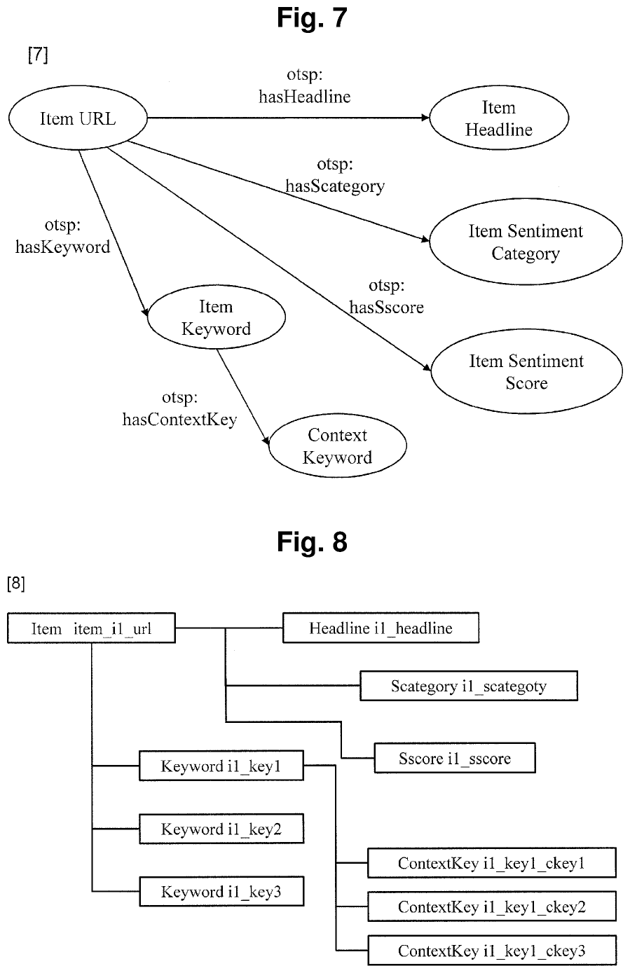

In this embodiment, a data structure example of a knowledge base, and a description example of a search rule are described. FIG. 7 shows a structure example of the recommended items and the context data shown in FIG. 6. For a URL of the recommended item, a headline, a sentiment analysis category, a sentiment analysis score and keywords are stored. The keywords are, for example, keywords extracted from the headline. For the keywords, context keywords associated with them may be stored.

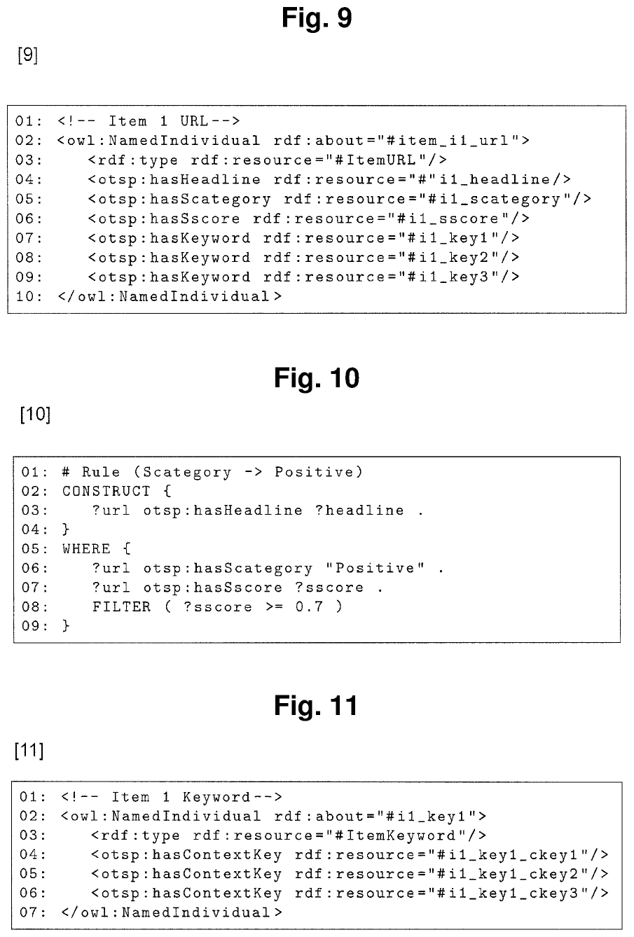

FIG. 8 shows an example of an instance created based on the data structure in FIG. 7. FIG. 9 shows instance representation for a recommended item 1 shown in FIG. 8. The name of this instance is item_i1_url. In the instance representation in FIG. 9, the instance in FIG. 8 is represented by owl.

FIG. 10 shows a rule description example when searching for recommended items. In this search rule, among the stored recommended items, a list of URLs and headlines of recommended items whose sentiment analysis category is “Positive” and whose sentiment analysis score is 0.7 or higher is obtained. By searching the list obtained in this way for those matching the keywords of the topic, it is possible to present recommended items suitable for a specific conversation. The data structure, the instance, the instance representation, and the description of the search rule shown here are examples, and other similar rule descriptions can be used.

FIG. 11 shows instance representation for a keyword. In this instance representation, it is shown that a keyword instance i1_key1 has context key instances i1_key1_ckey1, i1_key1_ckey2 and i1_key1_ckey3. The keyword instant and the context key instances are stored in the knowledge base 13 in advance, in consideration of their association.

As an example, i1_key1 is assumed to be “travel”, i1_key1_ckey1 is assumed to be “domestic”, i1_key1_ckey2 is assumed to be “sea”, and i1_key1_ckey3 is assumed to be “Okinawa”. As shown in the foregoing procedure, the topic of the current conversation and the topic context information about the topic can be obtained by extracting keywords of the conversation contents.

When the user is having a conversation about “travel”, the topic context extraction module 23 extracts keywords such as “domestic” and “sea”. These keywords correspond to the topic context. The similarity determination module 31 uses “domestic” and “sea” as the topic context, and searches the knowledge base 13 for similar contexts. As such, the recommended item 1 including “Okinawa” as a keyword is extracted. The similarity determination module 31 outputs an acquisition request for recommended items including “Okinawa” as a keyword to the information search module 32. The information search module 32 searches for recommended items using “Okinawa” as a search keyword.

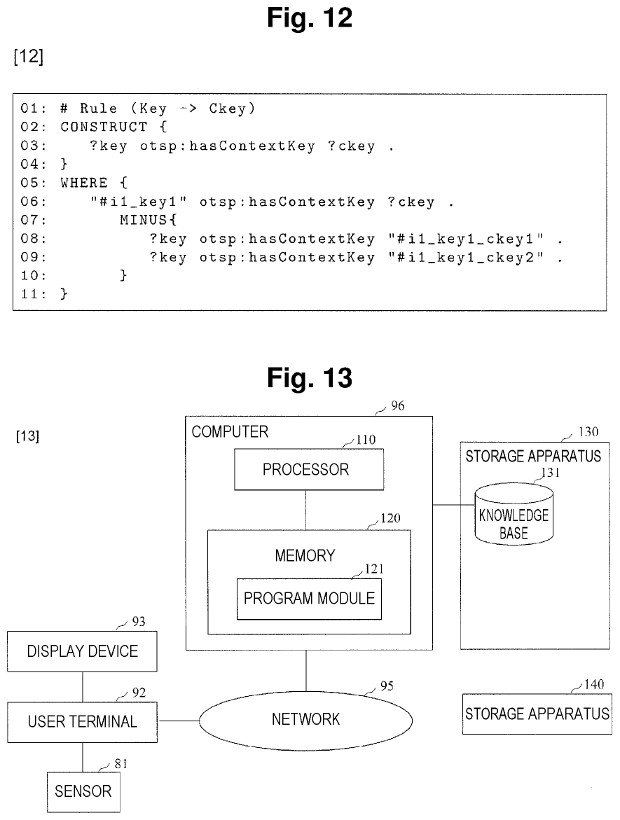

FIG. 12 shows a keyword linked search rule. According to this rule, when the keyword instance i1_key1 has the context key instances i1_key1_ckey1, i1_key1_ckey2 and i1_key1_ckey3, and i1_key1_ckey1: “domestic” and i1_key1_ckey2: “sea” have already been extracted during conversation, the information search module 32 can obtain as a similar context, i1_key1_ckey3: “Okinawa” as a search result from the knowledge base 13.

The keywords of the similar context obtained by the similarity determination module 31 are used in the search request for recommended items as described above. In this example, the topic in communication is used as the topic context, but environmental information from various sensors is transmitted and received using the sensor input/output module 21, and necessary information is sent out to the general-purpose context extraction module 22. As such, the general-purpose context extraction module 22 extracts from sensor information, general-purpose context information such as time information, environmental information, the user's location information, video information such as the user's facial expression and media being viewed, and a sentiment analysis category, and the information search module 32 can also search, taking them into account, for recommended items. The data structure, the instance, the instance representation, and the description of the search rule shown here are examples, and other similar rule descriptions can be used.

### Sixth Embodiment

In conversation scenes, it is conceivable to search for recommended items to be presented, in consideration of relationship between communication participants. So, in this embodiment, topics are provided in consideration of relationship between participants in communication and a result of sentiment analysis based on the relationship.

In this embodiment, basic information, hobbies, tastes and relationships of communication participants are stored in advance as user profiles, in the knowledge base 13 by description with RDF or the like. Moreover, user information with which a participant can be identified is also registered in the knowledge base 13 as a user profile. Identification of a participant can be associated with a user profile by image recognition by registering a face image in the knowledge base 13 in advance, or voice recognition during communication by registering the participant's voice data or feature quantity in the knowledge base 13 in advance. In this way, the similarity determination module 31 identifies the participants and their relationship by referring to the user profiles registered in the knowledge base 13.

As an example, when the similarity determination module 31 determines that the conversation is between people who meet for the first time, it outputs to the information search module 32 an acquisition request for recommended items whose sentiment analysis categories are “Positive”. There is a case such that if the conversation is between husband and wife, the similarity determination module 31 outputs to the information search module 32 an acquisition request also including recommended items whose sentiment analysis categories are “Negative”.

Consider the case where the information search module 32 uses the rule description example when searching for recommended items shown in FIG. 10. The information search module 32 can present, according to relationship between communication participants, a list of URLs and headlines of recommended items whose sentiment analysis category is “Positive” and whose sentiment analysis score is 0.7 or higher, or a list of URLs and headlines of recommended items whose sentiment analysis category is “Negative” and whose sentiment analysis score is 0.8 or higher.

In this example, relationship between participants in communication is used as general-purpose context information, but environmental information from the sensor 91 is transmitted and received by the sensor input/output module 21, and necessary information can be sent out to the general-purpose context extraction module 22. As such, the general-purpose context extraction module 22 extracts from sensor information, general-purpose context information such as time information, environmental information, the user's location information, and video information such as the user's facial expression and media being viewed, and the information search module 32 can also search, taking them into account, for recommended items. The data structure, the instance, the instance representation, and the description of the search rule shown here are examples, and other similar rule descriptions can be used.

### Seventh Embodiment

FIG. 13 shows an example of a hardware configuration of a system 100. The system 100 includes a computer 96 which functions as an information recommendation apparatus according to the present disclosure. The computer 96 may be connected to the network 95. The network 95 is a data communication network. Communication is performed by electronic signals and optical signals via the network 95.

The computer 96 includes a processor 110 and a memory 120 connected to the processor 110. The processor 110 is an electronic device composed of logic circuits which respond to instructions and execute the instructions. The memory 120 is a storage medium readable by the tangible computer 96, where computer programs are encoded. In this regard, the memory 120 stores data and instructions, i.e. program codes readable and executable by the processor 110 to control the operation of the processor 110. One of components of the memory 120 is a program module 121.

The program module 121 includes any module provided in this embodiment. For example, the program module 121 includes the sensor input/output module 21, the general-purpose context extraction module 22, the topic context extraction module 23, the context extraction module 24, the similarity determination module 31, the information search module 32, the recommended item output module 33, the recommended item collection module 11 and the communication context label extraction module 12.

The program module 121 includes instructions for controlling the processor 110 to execute processes described herein. The program module 121 is shown as already loaded into the memory 120, but it may be configured to be located on a storage apparatus 140 to be subsequently loaded into the memory 120. The storage apparatus 140 is a storage medium readable by a tangible computer, which stores the program module 121. Alternatively, the storage apparatus 140 may be another type of electronic storage device connected to the computer 96 via the network 95.

(Effect Caused by the Present Invention)

By applying the implementation technology in the present disclosure related to the above processing, storing association between a keyword and a context keyword in the knowledge base 13 in advance, and extracting a topic in conversation of the user 94 as keywords, it is possible to predict transition of the topic as a context. In the above-described embodiment, the sentiment analysis category, the sentiment analysis score and the keyword are shown as examples of the context, but the context of the present disclosure is not limited to them, and includes any communication context such as time and environment. The apparatus of the present disclosure can also be realized by a computer and a program, and the program can be recorded on a recording medium or provided through a network.

The present disclosure structures recommended items and context data, and stores them in the knowledge base 13. As such, in the present disclosure, it is possible to search for appropriate recommended items. The present disclosure includes a storage approach of recommended items, an assignment approach of context labels, a recommended item generation processing procedure, instance examples of recommended items and context data, instance representation of recommended items, a search rule of recommended items, and a keyword linked search rule, using the knowledge base 13.

As such, the present disclosure can provide an approach for realizing the following.

An approach for extracting as a context, topics during user's conversation or text dialogue, and a situation where the user's conversation is taking place.

A generation approach of recommended items suitable for conversation and dialogue, a storage method of recommended items, an assignment approach of context labels, and an approach for recognizing a situation during conversation as a context and searching for appropriate items.

A storage approach and a search approach of keywords and context keywords.

### INDUSTRIAL APPLICABILITY

The present disclosure can be applied to the information and communication industry.

### REFERENCE SIGNS LIST

11 Recommended item collection module
12 Communication context label extraction module
13 Knowledge base
21 Sensor input/output module
22 General-purpose context extraction module
23 Topic context extraction module
31 Similarity determination module
32 Information search module
33 Recommended item output module
91 Sensor
92 User terminal
93 Display device

1. An information recommendation apparatus comprising
a processor; and
a storage medium having computer program instructions stored thereon, when executed by the processor, perform to:
extracts keywords which are in a topic from a user's conversation,
refers to a knowledge base storing recommended items associated with communication contexts including keywords, extracts recommended items and communication contexts associated with the extracted keywords, and selects communication contexts similar to the topic among the extracted communication contexts, and
acquires from the knowledge base recommended items associated with the selected communication contexts.

2. The information recommendation apparatus according to claim 1, wherein the computer program instructions further perform to extracts sentiment of the user, and acquires from the knowledge base, recommended items which are suitable for the sentiment of the user, among the recommended items associated with the communication context selected.

3. The information recommendation apparatus according to claim 1, wherein
the knowledge base further stores a user profile for identifying the user, and the computer program instructions further perform to extracts user information for identifying the user, and refers to the knowledge base and identifies the user associated with the extracted user information to select a communication context suitable for relationship between participants of conversation among the communication contexts similar to the topic.

4. The information recommendation apparatus according to claim 1, wherein the computer program instructions further perform to
determines whether to search a data source different from the knowledge base, and
when it determines to search the data source different from the knowledge base, searches the data source different from the knowledge base for contents matching the communication context selected.

5. (canceled)

6. An information recommendation method, wherein
an information recommendation apparatus
extracts keywords which are in a topic in conversation,
refers to a knowledge base storing recommended items associated with communication contexts including keywords, extracts recommended items and communication contexts associated with the extracted keywords,
selects communication contexts similar to the topic among the extracted communication contexts, and
acquires from the knowledge base recommended items associated with the selected communication contexts.

7. A non-transitory computer-readable medium having computer-executable instructions that, upon execution of the instructions by a processor of a computer, cause the computer to function as the information recommendation apparatus according to claim 1.
